(19) United States
(12) Patent Application Publication
(10) Pub. No.: US 2025/0170874 A1
(43) Pub. Date: May 29, 2025

(54) METHOD FOR CONTROLLING A THERMAL CONDITIONING SYSTEM

(71) Applicant: VALEO SYSTEMES THERMIQUES, Le Mesnil-Saint-Denis (FR)

(72) Inventors: Bertrand Nicolas, Le Mesnil-Saint-Denis (FR); Mohamed Yahia, Le Mesnil-Saint-Denis (FR)

(73) Assignee: VALEO SYSTEMES THERMIQUES, Le Mesnil-Saint-Denis (FR)

(21) Appl. No.: 18/877,054

(22) PCT Filed: Jun. 20, 2023
(86) PCT No.: PCT/EP2023/066554

§ 371 Date: Dec. 19, 2024

(30) Foreign Application Priority Data
Jun. 20, 2022 (FR) 2205989

(51) Int. Cl. B60H 1/32; B60H 1/00

(52) U.S. Cl. CPC B60H 1/3205; B60H 1/00885; B60H 2001/3257; B60H 2001/3272; B60H 2001/3285; B60H 2001/3292

(57) ABSTRACT

A method for controlling a thermal conditioning system includes a heat-transfer fluid circuit and a refrigerant circuit. The refrigerant circuit includes an electric compressor, a first heat exchanger, a first pressure reducer, a second heat exchanger, and a bypass branch for returning a refrigerant at the outlet of the compressor to the second exchanger and a second pressure reducer. The method includes receiving a thermal power setpoint for delivering thermal power to a heat-transfer fluid; determining an electrical power setpoint for delivering electrical power to the compressor; determining a suction pressure setpoint for the compressor; controlling a flow cross-section of the second pressure reducer so that the suction pressure of the compressor is equal to the determined suction pressure setpoint; and controlling a flow cross-section of the first pressure reducer so that the refrigerant at the inlet of the compressor is in the superheated vapour state.

### TECHNICAL FIELD

The present invention relates to the field of thermal conditioning systems. Such thermal conditioning systems can notably be fitted to a motor vehicle. These systems make it possible to thermally regulate various parts of the vehicle, such as the vehicle interior or an electrical energy storage battery, if the vehicle has an electric drive train. Exchanges of heat are mainly managed by the compression and expansion of a refrigerant fluid within multiple heat exchangers.

### PRIOR ART

Thermal conditioning systems often make use of a refrigerant fluid circuit and a circuit for heat transfer liquid that exchanges heat with the refrigerant fluid. Such systems are thus referred to as indirect. A compressor brings the refrigerant fluid to a high pressure.

It is known practice to dispose in series, in the refrigerant fluid circuit, a first heat exchanger for heating an air stream intended for the vehicle interior, a second heat exchanger for heating an element of the drive train of the vehicle, such as an electrical energy storage battery, and a third heat exchanger for cooling this element of the drive train of the vehicle. Depending on the modes of operation, it is thus possible to supply heat to the element of the drive train of the vehicle in order to heat this element, or to collect heat from this element in order to transfer it for example to an air stream supplied to the vehicle interior, in order to heat the latter.

When the vehicle is started up at a cool ambient temperature, it is desirable to ensure a rapid rise in temperature of the vehicle interior, in order to ensure good thermal comfort for the occupants. For this, it is known practice to provide the refrigerant fluid circuit with a bypass branch allowing the refrigerant fluid leaving the compressor to reach the third exchanger without going via the first exchanger or via the second exchanger. The flow of high-pressure refrigerant fluid at the outlet of the compressor is divided into a flow circulating in the main loop and a flow circulating in the bypass branch. After having passed through the third heat exchanger, all of the flow of refrigerant fluid reaches the inlet of the compressor. This particular thermodynamic cycle makes it possible to increase the flow rate of refrigerant fluid circulating in the circuit, and thus increase the amount of energy received by the refrigerant fluid while it is being compressed. The rise in temperature of the refrigerant fluid is thus accelerated.

This mode of operation makes it possible to ensure an accelerated rise in temperature of the vehicle interior, but generally poses difficulties in controlling the operation of the compressor and the respective flows circulating in the main loop and in the bypass branch.

There is thus a need for an optimized control method for such a thermal conditioning system.

### SUMMARY

To this end, the present invention proposes a method for controlling a thermal conditioning system, the thermal conditioning system comprising:
a heat transfer liquid circuit configured to circulate a heat transfer liquid,
a refrigerant fluid circuit having:
   a main loop comprising, in succession in a flow direction of the refrigerant fluid:
      a compressor configured to be driven by an electric motor, the compressor being configured to bring the refrigerant fluid from an intake pressure to a delivery pressure,
      a first heat exchanger configured to supply a thermal power to a heat transfer fluid,
      a first expansion valve,
   a second heat exchanger arranged conjointly on the refrigerant fluid circuit and on the heat transfer liquid circuit so as to receive a thermal power (Pw2) from the heat transfer liquid,
a first bypass branch allowing the refrigerant fluid at the outlet of the compressor to reach the second exchanger by bypassing the first exchanger and the first expansion valve, the first bypass branch comprising a second expansion valve,

the control method comprising the following steps:
(i) receiving a thermal power setpoint for thermal power to be supplied at least to the heat transfer fluid at the first exchanger,
(ii) determining an electrical power setpoint for electrical power to be supplied to the electric motor of the compressor on the basis of the received thermal power setpoint for thermal power to be supplied and on the basis of the thermal power received by the second exchanger,
(iii) determining a delivery pressure setpoint on the basis of the determined electrical power setpoint and on the basis of a maximum delivery pressure,
(iv) determining an intake pressure setpoint on the basis of the determined electrical power setpoint and on the basis of the determined delivery pressure setpoint,
(v) controlling the rotational speed of the electric motor of the compressor such that the electrical power supplied to the compressor is equal to the determined setpoint,
(vi) controlling a passage cross section of the second expansion valve such that the intake pressure of the compressor is equal to the determined intake pressure setpoint, and
(vii) controlling a passage cross section of the first expansion valve such that the refrigerant fluid at the inlet of the compressor is in the superheated steam state.

This control structure makes it possible to robustly control the amount of refrigerant fluid circulating in the refrigerant fluid circuit, and the distribution of this refrigerant fluid flow between the flow circulating in the main loop and passing through the first exchanger, and the flow circulating in the first bypass branch and meeting the flow of the main branch downstream of the first expansion valve.

The features listed in the following paragraphs can be implemented independently of one another or in any technically possible combination:

According to one exemplary embodiment, the thermal conditioning system is a thermal conditioning system for a motor vehicle.

According to one embodiment, in step (ii), the setpoint for electrical power to be supplied to the electric motor of the compressor is equal to the received setpoint for thermal power to be supplied minus the thermal power received by the second exchanger.

According to one embodiment, in step (iv), the intake pressure setpoint is determined on the basis of the electrical power setpoint, on the basis of the determined delivery pressure setpoint, and on the basis of a maximum permissible rotational speed of the compressor.

The maximum permissible rotational speed may depend on the operating conditions. In particular, the maximum permissible rotational speed may depend on a speed of forward travel of the vehicle. As a result, the maximum permissible speed may be higher when the vehicle is running than when the vehicle is stopped.

The maximum delivery pressure may be a constant value, for example 27 bar.

The maximum delivery pressure may correspond to the maximum permissible pressure for ensuring the long-term reliability of the compressor. The use of a constant value makes it possible to simplify the control method.

According to one embodiment of the method, the setpoint for electrical power to be supplied to the electric motor of the compressor is for example equal to the received total heating power setpoint.

According to a variant, the setpoint for electrical power to be supplied to the electric motor of the compressor may be equal to the received total heating power setpoint divided by the adiabatic efficiency of the compressor.

The electrical power setpoint is thus calculated more precisely.

According to one embodiment of the method, the passage cross section of the first expansion valve is controlled by a proportional-integral controller.

Similarly, the passage cross section of the second expansion valve may be controlled by a proportional-integral controller.

This type of controller ensures robust control while still remaining easy to program and fine-tune.

According to one embodiment of the method, the control of the passage cross section of the first expansion valve and the control of the passage cross section of the second expansion valve are configured such that:
an increase in the passage cross section of the first expansion valve causes a reduction in the passage cross section of the second expansion valve, and
an increase in the passage cross section of the second expansion valve causes an increase in the passage cross section of the first expansion valve.

The coupling between the corrections made to the passage cross section of the first expansion valve and the corrections made to the passage cross section of the second expansion valve makes it possible to improve the control stability.

According to one embodiment of the method, in which the main loop of the refrigerant fluid circuit comprises a third expansion valve arranged downstream of the compressor and upstream of the first heat exchanger, the method comprises the following step:
(viii) controlling a refrigerant fluid passage cross section in the third expansion valve such that the delivery pressure is equal to the determined delivery pressure setpoint.

For this, step (viii) comprises a substep of: determining the delivery pressure (Pr_d).

Ensuring a partial expansion of the refrigerant fluid in the third expansion valve forces the compressor to compress the refrigerant fluid to a higher value than the condensation pressure in the first exchanger. The thermal power received by the refrigerant fluid is thus increased, and this makes it possible to accelerate the rise in temperature of the thermal conditioning system.

According to one embodiment, the method comprises the following steps:
(vii1) determining a superheating of the refrigerant fluid at the inlet of the compressor,
(vii2) controlling a passage cross section of the first expansion valve such that the superheating of the refrigerant fluid at the inlet of the compressor is equal to a setpoint value.

The superheating setpoint at the inlet of the compressor is selected so as to ensure that the refrigerant taken in by the compressor is in entirely gaseous form. This ensures the reliability of the compressor.

The setpoint value for the superheating of the refrigerant fluid at the inlet of the compressor ranges for example between 5° C. and 15° C.

According to one embodiment, the method comprises the following steps:
(vii1) determining a superheating of the refrigerant fluid at the outlet of the compressor,
(vii2) controlling a passage cross section of the first expansion valve such that the superheating of the refrigerant fluid at the outlet of the compressor is equal to a setpoint value.

Controlling the superheating setpoint at the outlet of the compressor is another way of ensuring that the refrigerant taken in by the compressor is in substantially entirely gaseous form. This ensures the reliability of the compressor.

The setpoint value for the superheating of the refrigerant fluid at the outlet of the compressor ranges between 15° C. and 35° C.

According to one embodiment of the method, in which the main loop of the thermal conditioning system comprises, downstream of the first heat exchanger and upstream of the first expansion device, a third heat exchanger arranged conjointly on the refrigerant fluid circuit and on the heat transfer liquid circuit so as to enable an exchange of heat between the refrigerant fluid and the heat transfer liquid, the third heat exchanger being configured to supply a thermal power to the heat transfer liquid, and in which, in step (i),
the thermal power setpoint for thermal power to be supplied is a total thermal power, which is the sum of the thermal power to be supplied to the heat transfer fluid at the first exchanger and the thermal power to be supplied to the heat transfer liquid at the third exchanger.

According to one exemplary embodiment of the method, the heat transfer fluid is an air stream inside a motor vehicle interior.

According to another exemplary embodiment of the method, the heat transfer fluid is a heat transfer liquid configured to circulate in a fifth heat exchanger configured to exchange heat with an air stream inside the vehicle interior.

According to one embodiment of the method, the second heat exchanger is thermally coupled to an element of a drive train of the vehicle, via the heat transfer liquid in the heat transfer liquid circuit.

The second heat exchanger thus makes it possible to absorb heat from the element of the drive train of the vehicle, in order to keep its temperature within an acceptable range or in order to transfer the absorbed heat to another part.

According to one embodiment of the method, the third heat exchanger is thermally coupled to the element of a drive train of the vehicle, via the heat transfer liquid in the heat transfer liquid circuit.

The third heat exchanger thus makes it possible to supply a thermal power to the element of the drive train of the vehicle, which is to say to heat this element in order to increase its temperature.

The element of the electric drive train comprises for example an electric traction motor of the vehicle.

In a variant or additionally, the element of the electric drive train comprises an electronic module for operating an electric traction motor of the vehicle.

In another variant, or additionally, the element of the electric drive train comprises an electrical energy storage battery.

The invention also relates to a thermal conditioning system comprising:
a heat transfer liquid circuit configured to circulate a heat transfer liquid,
a refrigerant fluid circuit having:
   a main loop comprising, in succession in a flow direction of the refrigerant fluid:
      a compressor configured to be driven by an electric motor, the compressor being configured to bring the refrigerant fluid from an intake pressure to a delivery pressure,
      a first heat exchanger configured to supply a thermal power to a heat transfer fluid,
      a first expansion valve,
      a second heat exchanger arranged conjointly on the refrigerant fluid circuit and on the heat transfer liquid circuit so as to receive a thermal power from the heat transfer liquid,
   a first bypass branch allowing the refrigerant fluid at the outlet of the compressor to reach the second exchanger by bypassing the first exchanger and the first expansion valve, the first bypass branch comprising a second expansion valve,
an electronic control unit configured to implement the control method described above.

According to one embodiment of the thermal conditioning system, the refrigerant fluid circuit comprises a second bypass branch disposed in parallel with the first expansion valve and the second heat exchanger, the second bypass branch comprising a fourth expansion valve and a fourth heat exchanger.

For example, the fourth heat exchanger is configured to exchange heat with an air stream inside the vehicle interior.

According to one aspect of the thermal regulation system, the main loop of refrigerant fluid comprises a refrigerant fluid accumulation device disposed downstream of the first exchanger and upstream of the first expansion valve.

In one embodiment, the main loop of refrigerant fluid comprises a refrigerant fluid accumulation device disposed downstream of the first exchanger and upstream of the first expansion valve. In one embodiment, in which the main loop of refrigerant fluid comprises the first exchanger and the third exchanger, the refrigerant fluid accumulation device is disposed downstream of the third exchanger and upstream of the first expansion valve.

According to one embodiment of the thermal conditioning system, the main loop of refrigerant fluid comprises an internal exchanger configured to enable an exchange of heat between the high-pressure refrigerant fluid downstream of the third heat exchanger and upstream of the first expansion valve, and the low-pressure refrigerant fluid downstream of the second exchanger and upstream of the compressor.

According to one aspect of the thermal conditioning system, it comprises a first bypass branch fluidically connecting a first junction point disposed on the main loop downstream of the compressor and upstream of the first exchanger to a second junction point disposed on the main loop downstream of the first expansion valve and upstream of the second exchanger, the first bypass branch having a second expansion device.

According to one embodiment, the thermal conditioning system comprises a second bypass branch fluidically connecting a third junction point disposed on the main loop downstream of the third exchanger and upstream of the first expansion valve to a fourth junction point disposed on the main loop downstream of the second exchanger and upstream of the compressor, the second bypass branch having a fourth expansion device disposed upstream of a fourth heat exchanger.

### BRIEF DESCRIPTION OF THE DRAWINGS

Further features, details and advantages will become apparent on reading the detailed description below, and on studying the appended drawings, in which:

FIG. 1 is a schematic view of a thermal conditioning system according to a first embodiment, in which the control method according to the invention is implemented,

FIG. 2 is a schematic view of a thermal conditioning system according to a second embodiment, in which the control method according to the invention is implemented,

FIG. 3 is a schematic view of a variant of the thermal conditioning system in FIG. 2,

FIG. 4 is a schematic view of another variant of the thermal conditioning system in FIG. 2,

FIG. 5 is a thermodynamic diagram schematically showing the state of the refrigerant fluid when the control method is implemented,

FIG. 6 is a curve illustrating the operation of the control method,

FIG. 7 is a block diagram illustrating various steps of the method according to the invention.

### DESCRIPTION OF THE EMBODIMENTS

To make the figures easier to read, the various elements are not necessarily shown to scale. In these figures, elements that are identical bear the same references. Certain elements or parameters may be indexed, which is to say designated for example as first element or second element, or first parameter and second parameter, etc. This indexing is intended to differentiate elements or parameters that are similar but not identical. This indexing does not imply that one element or parameter takes priority over another, and the denominations may be interchanged.

In the following description, the expression “a first element upstream of a second element” means that the first element is placed before the second element with respect to the direction of circulation, or travel, of a fluid. Similarly, the expression “a first element downstream of a second element” means that the first element is placed after the second element with respect to the direction of circulation, or travel, of the fluid in question. In the case of the refrigerant fluid circuit, the expression “a first element is upstream of a second element” means that the refrigerant fluid travels in succession through the first element and then the second element, without going via the compression device. In other words, the refrigerant fluid leaves the compression device, possibly passes through one or more elements and then passes through the first element, then the second element, and then returns to the compression device, in some cases having passed through further elements.

The expression “a second element is placed between a first element and a third element” means that the shortest path from the first element to the third element goes via the second element. When it is specified that a sub-system has a given element, this does not rule out the presence of other elements in this sub-system.

In the thermal conditioning system 100 described, an electronic control unit 50 receives information from various sensors, not shown, measuring in particular the physical characteristics of the refrigerant fluid at various points of the circuit. The electronic control unit also receives setpoints issued by the occupants of the vehicle, such as the desired temperature in the vehicle interior. The electronic control unit implements control laws for operating the various actuators, in order to control the thermal conditioning system 100 so as to achieve the setpoints received. The electronic control unit 50 in particular implements the method according to the invention.

The compression device 7 may be an electric compressor, which is to say a compressor of which the moving parts are driven by an electric motor 6. The compression device 7 has an intake side for the low-pressure refrigerant fluid, also referred to as inlet 7a of the compression device, and a delivery side for the high-pressure refrigerant fluid, also referred to as outlet 7b of the compression device 7. The internal moving parts of the compressor 7 bring the refrigerant fluid from a low pressure, or intake temperature Pr_s, on the inlet side 7a, to a high pressure, or delivery pressure Pr_d, on the outlet side 7b. After expansion in one or more expansion devices, the refrigerant fluid returns to the inlet 7a of the compressor 7 and begins a new thermodynamic cycle again.

The refrigerant fluid circuit 10 forms a closed circuit in which the refrigerant fluid can circulate. The refrigerant fluid circuit 10 is sealed when it is in a nominal operating state, i.e. an operating state without a fault or leak. Each junction point of the circuit 10 allows the refrigerant fluid to enter one or the other of the circuit portions that meet at this junction point. The refrigerant fluid is distributed between the circuit portions meeting at a junction point by adjusting the opening or closure of the shut-off valves, non-return valves or expansion device of each of the branches. In other words, each junction point is a means for redirecting the refrigerant fluid arriving at this junction point. Shut-off valves and non-return valves thus make it possible to selectively direct the refrigerant fluid into the various branches of the refrigerant circuit in order to provide different modes of operation, as will be described later on.

The refrigerant fluid used by the refrigerant fluid circuit 1 is in this case a chemical fluid such as R1234yf. Other refrigerant fluids may also be used, such as R134a, R290 or R744.

An internal air stream Fi is understood to mean an air stream intended for the motor vehicle interior. This internal air stream may circulate in an HVAC (Heating, Ventilating and/or Air Conditioning) installation. This installation has not been shown in the various figures. Engine fans, not shown, may be activated in order to increase the flow rate of the internal air stream Fi if necessary.

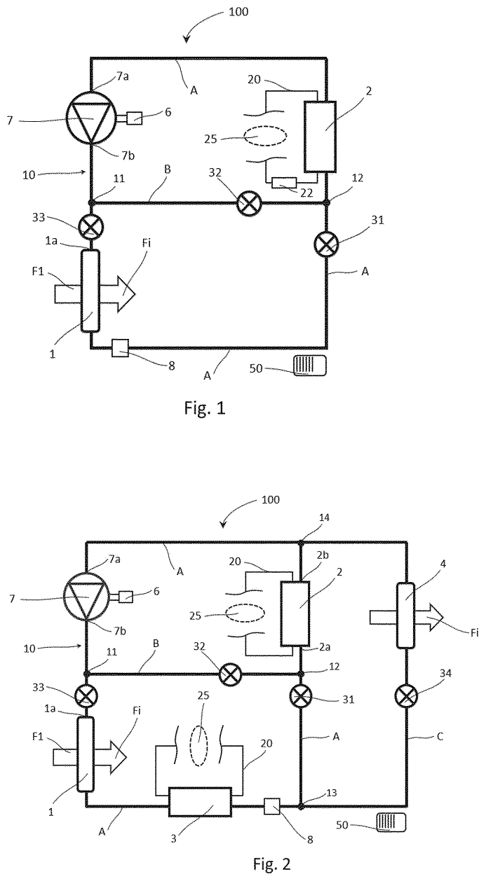

FIG. 1 shows a thermal conditioning system 100 comprising:
a heat transfer liquid circuit 20 configured to circulate a heat transfer liquid,
a refrigerant fluid circuit 10 having:
   a main loop A comprising, in succession in a flow direction of the refrigerant fluid:
      a compressor 7 configured to be driven by an electric motor 6, the compressor 7 being configured to bring the refrigerant fluid from an intake pressure Pr_s to a delivery pressure Pr_d,
      a first heat exchanger 1 configured to supply a thermal power Pw1 to a heat transfer fluid F1,
      a first expansion valve 31,
      a second heat exchanger 2 arranged conjointly on the refrigerant fluid circuit 10 and on the heat transfer liquid circuit 20 so as to receive a thermal power Pw2 from the heat transfer liquid,
   a first bypass branch B allowing the refrigerant fluid at the outlet of the compressor 7 to reach the second exchanger 2 by bypassing the first exchanger 1 and the first expansion valve 31, the first bypass branch B comprising a second expansion valve 32,
an electronic control unit 50 configured to implement the control method that will be described in detail below.

The first heat exchanger 1 is configured to exchange heat with the heat transfer fluid F1. The first heat exchanger 1 may act as a condenser. The heat of condensation of the refrigerant fluid is transferred to the heat transfer fluid F1. A thermal power Pw1 is thus supplied to the heat transfer fluid F1.

The second heat exchanger 2 is a bi-fluid exchanger. In other words, the second heat exchanger 2 comprises a first compartment through which the refrigerant fluid travels and a second compartment through which the heat transfer liquid travels. The two compartments are leaktight and may perform an exchange of heat. The bi-fluid exchanger comprises a refrigerant fluid inlet and outlet, and a heat transfer liquid inlet and outlet. Within the second exchanger 2, the refrigerant fluid may thus receive a thermal power Pw2 from the heat transfer liquid. A heating element 22, for example an electric heating element, may be disposed on the heat transfer liquid circuit 20 in order to heat the heat transfer liquid under certain operating conditions. A thermal power Pw2 is thus transferred from the heat transfer liquid to the refrigerant fluid within the second exchanger 2. The heating element 22 is optional.

Each expansion valve of the thermal conditioning system 100 is a device for expanding the refrigerant fluid. Each expansion valve is configured to vary a refrigerant fluid passage cross section. Each expansion valve comprises a refrigerant fluid inlet and a refrigerant fluid outlet. The outlet and the inlet are fluidically connected by a duct. A movable shutter makes it possible to control the passage cross section of the duct, which is to say the passage surface area provided to the refrigerant fluid. The expansion valve is for example an electronic expansion valve, which is to say that the movable shutter is actuated by an electric motor commanded by an electronic control module. The position of the movable shutter can be subjected to closed-loop control, which is to say that the position of the movable shutter is measured and regulated in real time so as to obtain a position setpoint. The refrigerant fluid passage cross section can be regulated continuously between a closed position and a position of maximum opening. The electronic control module of each expansion valve may be integrated in the corresponding expansion valve. According to a variant, the electronic control unit 50 may also command and control each expansion valve.

The first expansion valve 31 is configured to vary the refrigerant fluid passage cross section in the circuit portion located downstream of the first exchanger 1 and upstream of the second junction point 12. The second expansion valve 32 is configured to vary a refrigerant fluid passage cross section in the first bypass branch B.

According to one exemplary embodiment, the thermal conditioning system 100 is a thermal conditioning system for a motor vehicle.

In the embodiment in FIG. 1, the heat transfer fluid F1 is an air stream Fi inside a motor vehicle interior. The first heat exchanger 1 is disposed in the heating, ventilating and/or air conditioning installation.

The second heat exchanger 2 is in this case thermally coupled to an element 25 of an electric drive train of the vehicle. The thermal coupling is realized via the heat transfer liquid in the heat transfer liquid circuit 20. For this, the heat transfer liquid circulating in the heat transfer liquid circuit 20 exchanges heat with the element 25 of the drive train of the vehicle.

The second heat exchanger 2 thus makes it possible to absorb heat from the element 25 of the drive train of the vehicle. The heat given off by the operation of the element 25 is transferred to the heat transfer liquid in the circuit 20. Depending on the operating conditions, the temperature of the element 25 may be kept within an acceptable range, or the heat absorbed may be transferred to another part in order to heat this other part.

The element 25 of the electric drive train comprises for example an electric traction motor of the vehicle. In a variant, or additionally, the element 25 of the electric drive train comprises an electrical energy storage battery. In another variant or additionally, the element 25 of the electric drive train comprises an electronic module for operating an electric traction motor of the vehicle.

The first bypass branch B fluidically connects a first junction point 11 disposed on the main loop A downstream of the compressor 7 and upstream of the first exchanger 1 to a second junction point 12 disposed on the main loop A downstream of the first expansion valve 31 and upstream of the second exchanger 2. It will thus be understood that the first bypass branch B establishes fluidic communication between the first junction point 11 and the second junction point 12. The first bypass branch B has a second expansion device 32.

The main loop A of refrigerant fluid comprises a refrigerant fluid accumulation device 8 disposed downstream of the first exchanger 1 and upstream of the first expansion valve 31. The refrigerant fluid accumulation device 8 is a receiver-dryer.

The present invention proposes a method for controlling a thermal conditioning system 100, the thermal conditioning system 100 comprising:
a heat transfer liquid circuit 20 configured to circulate a heat transfer liquid,
a refrigerant fluid circuit 10 having:
   a main loop A comprising, in succession in a flow direction of the refrigerant fluid:
      a compressor 7 configured to be driven by an electric motor 6, the compressor 7 being configured to bring the refrigerant fluid from an intake pressure Pr_s to a delivery pressure Pr_d,
      a first heat exchanger 1 configured to supply a thermal power Pw1 to a heat transfer fluid F1,
      a first expansion valve 31,
      a second heat exchanger 2 arranged conjointly on the refrigerant fluid circuit 10 and on the heat transfer liquid circuit 20 so as to enable an exchange of heat between the refrigerant fluid and the heat transfer liquid,
   a first bypass branch B allowing the refrigerant fluid at the outlet of the compressor 7 to reach the second exchanger 2 by bypassing the first exchanger 1 and the first expansion valve 31, the first bypass branch B having a second expansion valve 32,

the control method comprising the following steps:
(i) receiving a thermal power setpoint C_Pw for thermal power to be supplied at least to the heat transfer fluid F1 at the first exchanger 1,
(ii) determining an electrical power setpoint C_Pw_el for electrical power to be supplied to the electric motor 6 of the compressor 7 on the basis of the received thermal power setpoint C_Pw for thermal power to be supplied and the thermal power Pw2 received by the second exchanger 2,
(iii) determining a delivery pressure setpoint C_Pr_d on the basis of the determined electrical power setpoint C_Pw_el and on the basis of a maximum delivery pressure Pr_d_max,
(iv) determining an intake pressure setpoint C_Pr_s on the basis of the determined electrical power setpoint C_Pw_el and on the basis of the determined delivery pressure setpoint C_Pr_d,
(v) controlling the rotational speed N of the electric motor 6 of the compressor 7 such that the electrical power Pw_el supplied to the compressor 7 is equal to the determined setpoint C_Pw_el,
(vi) controlling a passage cross section of the second expansion valve 32 such that the intake pressure Ps of the compressor 7 is equal to the determined intake pressure setpoint C_Pr_s, and
(vii) controlling a passage cross section of the first expansion valve 31 such that the refrigerant fluid at the inlet of the compressor 7 is in the superheated steam state.

This control structure makes it possible to robustly control the amount of refrigerant fluid circulating in the refrigerant fluid circuit, and the distribution of this refrigerant fluid flow between the flow circulating in the main loop and passing through the first exchanger, and the flow circulating in the first bypass branch and meeting the flow of the main branch downstream of the first expansion valve.

In step (ii), the electrical power setpoint C_Pw_el for electrical power to be supplied to the electric motor 6 of the compressor 7 is equal to the received thermal power setpoint C_Pw for thermal power to be supplied minus the thermal power Pw2 received by the second exchanger 2.
Specifically: C_Pw_el=C_Pw−Pw2

In step (iv), the intake pressure setpoint C_Pr_s is determined on the basis of the electrical power setpoint C_Pw_el, on the basis of the determined delivery pressure setpoint C_Pr_d, and on the basis of a maximum permissible rotational speed of the compressor 7.

The maximum permissible rotational speed depends on a speed of forward travel of the vehicle. As a result, the maximum permissible speed may be higher when the vehicle is running than when the vehicle is stopped, since the background noise is higher when the vehicle is running. The maximum permissible rotational speed may for example be mapped as a function of the speed of the vehicle, which is to say that the value of the maximum permissible rotational speed is looked up in a table at an input, the input being the speed of the vehicle.

The maximum delivery pressure Pr_d_Max may be a constant value, for example 27 bar.

The maximum delivery pressure Pr_d_Max may correspond to the maximum permissible pressure for ensuring the long-term reliability of the compressor 7. The use of a constant value makes it possible to simplify the control method.

According to a variant, the maximum delivery pressure Pr_d_Max may be a tabulated value, for example a value tabulated on the basis of a speed of forward travel of the vehicle. A tabulated value is understood to mean that the value of the maximum delivery pressure may be looked up in a table, also referred to as map, assigning various output values depending on the input value of the table.

The maximum delivery pressure Pr_d_Max can thus depend on the operating conditions. For example, the maximum delivery pressure Pr_d_Max may depend on the speed of forward travel of the vehicle. Thus, the maximum pressure supplied by the compressor 7 may be limited when the vehicle is stopped, in order to limit the noise generated which can be particularly annoying when no noise is being generated by the vehicle running.

According to one embodiment of the method, the electrical power setpoint E_Pw_el for electrical power to be supplied to the electric motor 6 of the compressor 7 is for example equal to the received total heating power setpoint. In other words, the efficiency of the compressor 7 is assumed to be ideal.

According to a variant, the electrical power setpoint C_Pw_el for electrical power to be supplied to the electric motor 6 of the compressor 7 may be equal to the received total heating power setpoint divided by the adiabatic efficiency of the compressor 7. In this case, the electrical power setpoint is thus calculated more precisely, since the efficiency is no longer assumed to be ideal. The efficiency may be characterized under various operating conditions and for example mapped.

The passage cross section of the first expansion valve 31 is controlled for example by a proportional-integral controller. Similarly, the passage cross section of the second expansion valve 32 may be controlled by a proportional-integral controller. This type of controller ensures robust control while still remaining easy to program and fine-tune.

According to one embodiment of the method, the control of the passage cross section of the first expansion valve 31 and the control of the passage cross section of the second expansion valve 32 are configured such that:
an increase in the passage cross section of the first expansion valve 31 causes a reduction in the passage cross section of the second expansion valve 32, and
an increase in the passage cross section of the second expansion valve 32 causes an increase in the passage cross section of the first expansion valve 31.

The coupling between the corrections made to the passage cross section of the first expansion valve 31 and the corrections made to the passage cross section of the second expansion valve 32 makes it possible to improve the control stability. The gain associated with the reduction in the passage cross section of the second expansion valve 32 is for example equal to half the gain associated with the increase in the passage cross section of the first expansion valve 31. Thus, when the controller opens the first expansion valve 31 by a certain amount, it conjointly closes the second expansion valve 32 by a value equal to half this amount.

According to the example described here, the main loop A of the refrigerant fluid circuit 10 comprises a third expansion valve 33 arranged downstream of the compressor 7 and upstream of the first heat exchanger 1, and the method comprises the following step:
(viii) controlling a refrigerant fluid passage cross section in the third expansion valve 33 such that the delivery pressure Pr_d is equal to the determined delivery pressure setpoint C_Pr_d.
Step (viii) thus comprises a substep of: determining the delivery pressure Pr_d.

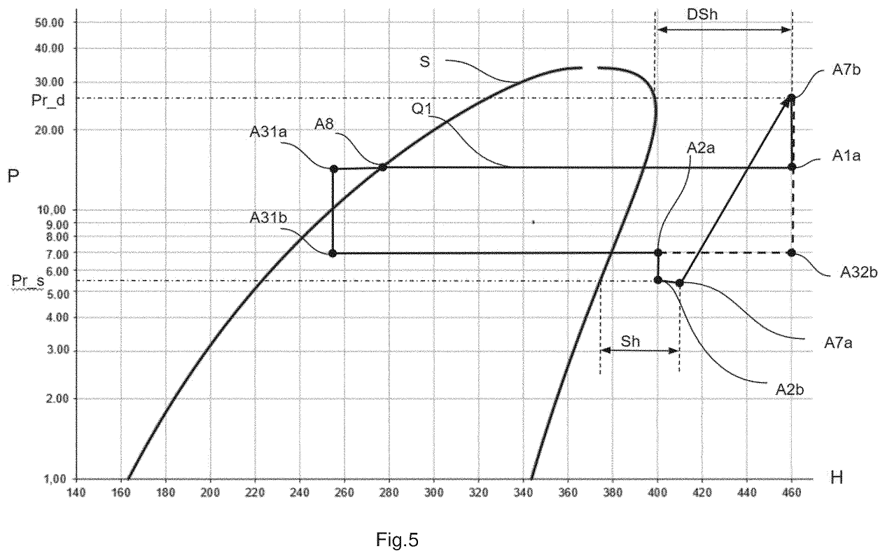

FIG. 5 illustrates the thermodynamic state of the refrigerant fluid during the thermodynamic cycle described. The value on the abscissa axis is the enthalpy of the refrigerant fluid. The value on the ordinate axis is the pressure of the refrigerant fluid, on a logarithmic scale. Curve S is the saturation curve characteristic of the refrigerant fluid used. The region of the diagram between the saturation curve S and the abscissa axis corresponds to the biphasic domain of the refrigerant fluid.

Point A7a represents the state of the refrigerant fluid at the inlet of the compressor 7. The pressure of the refrigerant fluid at that point is equal to the intake pressure Pr_s. Point A7b represents the state of the refrigerant fluid at the outlet of the compressor 7. The pressure at that point is equal to the delivery pressure Pr_d. Point A1a represents the state of the refrigerant fluid at the inlet 1a of the first exchanger 1. The third expansion valve 33 brings about a partial expansion of the refrigerant fluid, such that the pressure of the refrigerant fluid in the first exchanger 1 is less than the delivery pressure Pr_d of the compressor 7.

Ensuring a partial expansion of the refrigerant fluid in the third expansion valve 33 forces the compressor 7 to compress the refrigerant fluid to a higher value than the condensation pressure in the first exchanger 1. This increases the thermal power received by the refrigerant fluid while it is being compressed. The rise in temperature of the thermal conditioning system 100 is thus accelerated. In addition, using as high as possible a delivery pressure makes it possible to reduce the rotational speed of the compressor 7 and thus reduce the level of operating noise.

The flow of high-pressure refrigerant fluid at the outlet of the compressor 7 is divided between a first flow which circulates in the main loop A and passes through the first exchanger 1, and a second flow which circulates in the first bypass branch B, the division into two flows being performed at the first junction point 11. The refrigerant fluid circulating in the main loop A and partially expanded by the third expansion valve 33 condenses in the first exchanger 1 by giving up heat to the heat transfer fluid F1. Indicator Q1 indicates the amount of heat transferred, and point A8 characterizes the state of the refrigerant fluid at the outlet of the accumulation device 8. The refrigerant fluid leaving the first exchanger 1 is then expanded at the first expansion valve 31. Point A31a characterizes the state of the refrigerant fluid at the inlet of the first expansion valve 31 and point A31b the state at the outlet of the first expansion valve 31, which is to say after the expansion. At this point, the refrigerant fluid is biphasic, being mainly in liquid form.

The flow circulating in the first bypass branch B undergoes an expansion at the second expansion valve 32. Point A32b represents the thermodynamic state of the refrigerant fluid at the outlet of the second expansion valve 32. At this point of the cycle, the refrigerant fluid is in the superheated steam state. This flow of superheated steam circulating in the first bypass branch B is mixed with the flow of biphasic refrigerant fluid circulating in the main loop A at the second junction point 12, and reaches the inlet 2a of the second exchanger 2. Point A2a illustrates the state of the mixing point. The flow of superheated steam is controlled such that the mixture obtained is in entirely gaseous form, which is to say in superheated steam form. This ensures the reliability of the compressor 7, since the compressor 7 does not run the risk of receiving refrigerant in the liquid state. Point A2b represents the state of the refrigerant fluid at the outlet of the second exchanger 2. The exchange of heat is negligible at the second exchanger 2. In FIG. 5, the head loss generated by the second exchanger 2 has been exaggerated to make the figure easier to read. The refrigerant fluid leaving the second exchanger 2 reaches the inlet of the compressor 7, characterized by point A7a. The thermodynamic cycle is thus completed.

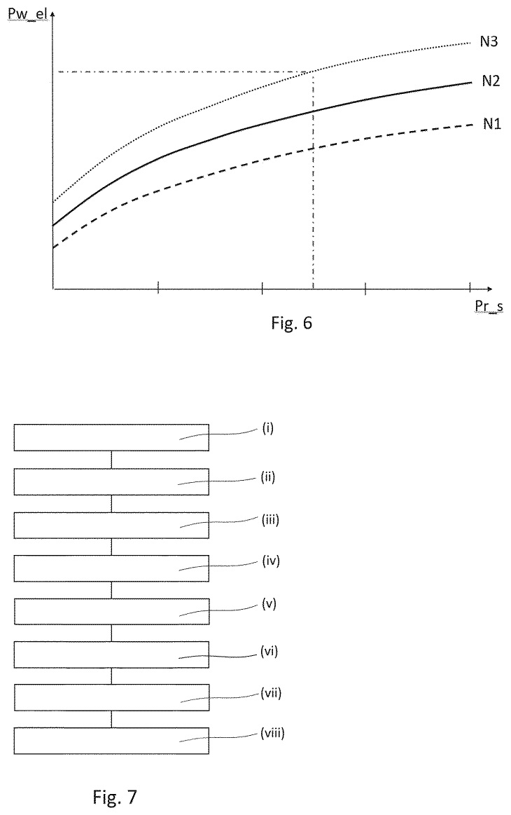

FIG. 6 illustrates the relationship between the intake pressure Pr_s at the inlet of the compressor and the electrical power Pw_el supplied to the compressor, for a given fixed delivery pressure Pr_d, for example 25 bar. Curve N1 corresponds to a rotational speed N of the compressor which is constant, in this case equal to 5000 rpm. Curve N2 corresponds to a speed greater than N1, in this case 6000 rpm, and curve N3 corresponds to a constant speed greater than N2, in this case 7000 rpm. At a constant rotational speed, the electrical power consumed by the compressor is an increasing function of the intake pressure Pr_s. For a given intake pressure, the electrical power consumed by the electric motor 6 to drive the compressor 7 increases as the rotational speed increases. Such a cluster of curves is determined for the entire range of rotational speeds of the compressor 7, for the entire range of permissible intake pressures and the entire range of permissible delivery pressures. The cluster of curves allows the control method to determine the intake pressure, the delivery pressure and the rotational speed that make it possible to obtain the setpoint for electrical pressure consumed by the compressor, and from there to obtain the setpoint for thermal power to be given off.

According to one embodiment, the method comprises the following steps:
(vii1) determining a superheating Sh of the refrigerant fluid at the inlet of the compressor 7,
(vii2) controlling a passage cross section of the first expansion valve 31 such that the superheating Sh of the refrigerant fluid at the inlet of the compressor 7 is equal to a setpoint value C_Sh.

The superheating setpoint C_Sh at the inlet of the compressor 7 is selected so as to ensure that the refrigerant taken in by the compressor 7 is in entirely gaseous form, in order to ensure the reliability of the compressor 7. The control of the passage cross section of the second expansion valve 32 makes it possible to control the flow of superheated steam circulating in the first bypass branch B and therefore to control the composition of the mixture illustrated by point A2a.

The setpoint value C_Sh for the superheating of the refrigerant fluid at the inlet of the compressor 7 ranges for example between 5° C. and 15° C.

By definition, the superheating at the inlet of the compressor 7 is equal to the temperature of the refrigerant fluid at the inlet of the compressor 7 minus the value of the condensation temperature of the refrigerant fluid corresponding to the pressure of the refrigerant fluid at the inlet of the compressor 7, which is to say the intake pressure Pr_s. The temperature of the refrigerant fluid is for example measured by a temperature sensor, the sensing element of which is in contact with the refrigerant fluid. Similarly, the pressure of the refrigerant fluid is for example measured by a pressure sensor, the sensing element of which is in contact with the refrigerant fluid.

According to another embodiment, the method comprises the following steps:
(vii1′) determining a superheating Dsh of the refrigerant fluid at the outlet of the compressor 7,
(vii2′) controlling a passage cross section of the first expansion valve 31 such that the superheating of the refrigerant fluid at the outlet of the compressor 7 is equal to a setpoint value C_Dsh.

Controlling the superheating setpoint C_Dsh at the outlet of the compressor 7 is another way of ensuring that the refrigerant taken in by the compressor 7 is in entirely gaseous form, so as to ensure the reliability of the compressor 7.

The setpoint value C_Dsh for the superheating of the refrigerant fluid at the outlet of the compressor 7 ranges between 15° C. and 35° C.

The superheating Dsh at the outlet of the compressor 7 is equal to the measured temperature of the refrigerant fluid at the outlet of the compressor 7 minus the value of the condensation temperature of the refrigerant fluid corresponding to the pressure of the refrigerant fluid at the outlet of the compressor 7, which is to say the delivery pressure Pr_d.

FIG. 2 illustrates a second embodiment of the thermal conditioning system 100, in which the control method is implemented. In this second embodiment, the main loop A of the thermal conditioning system 100 comprises, downstream of the first heat exchanger 1 and upstream of the first expansion device 31, a third heat exchanger 3 arranged conjointly on the refrigerant fluid circuit 10 and on the heat transfer liquid circuit 20 so as to enable an exchange of heat between the refrigerant fluid and the heat transfer liquid. The third heat exchanger 3 is configured to supply a thermal power Pw3 to the heat transfer liquid.

In step (i) of the control method, the thermal power setpoint Pw for thermal power to be supplied is a total thermal power Pw_tot, which is the sum of the thermal power Pw1 to be supplied to the heat transfer fluid F1 at the first exchanger 1 and the thermal power Pw3 to be supplied to the heat transfer liquid at the third exchanger 3.

Whereas in the first embodiment, the refrigerant fluid supplies a thermal power only to the first heat transfer fluid F1 at the first exchanger 1, in the second embodiment the refrigerant fluid supplies a thermal power also to the heat transfer liquid in the circuit 20, at the third exchanger 3. The thermal power setpoint Pw for thermal power to be supplied corresponds to the total power to be supplied, which is to say the thermal power supplied by the first exchanger 1 to which the thermal power supplied by the third exchanger 3 is added.

The third heat exchanger 3 is a bi-fluid exchanger. It may have a similar structure to that of the second exchanger 2. Its exchangers are for example plate exchangers.

In other words, in this second embodiment, the main loop A comprises, in series and in this order: the compressor 7, the first junction point 11, the third expansion valve 33, the first exchanger 1, the third exchanger 3, the accumulation device 8, the first expansion valve 31, the second junction point 12, the second exchanger 2, and the circuit portion extending between the outlet 2b of the second exchanger 2 and the inlet 7a of the compressor 7. The condensation of the high-pressure refrigerant fluid takes place partially in the first exchanger 1 and partially in the second exchanger 2. The first heat transfer fluid F1 can thus be heated at the first exchanger 1 and the heat transfer liquid in the circuit 20 can be heated at the third exchanger 3. The total thermal power Pw to be supplied is distributed between the thermal power Pw1 supplied by the first exchanger 1 to the first heat transfer fluid F1 and the thermal power Pw3 supplied by the third exchanger 3 to the heat transfer liquid circulating in the heat transfer liquid circuit 20. The distribution between the thermal power Pw1 and the thermal power Pw3 can be realized by adjusting control parameters which will not be set out in detail.

In this embodiment, the first bypass branch B allows the refrigerant fluid at the outlet of the compressor 7 to reach the second exchanger 2 by bypassing the first exchanger 1, the third exchanger 3 and the first expansion valve 31. Specifically, the first bypass branch B connects a point disposed upstream of the third expansion valve 33 to a point disposed downstream of the first expansion valve 31.

In this embodiment, the main loop A of refrigerant fluid comprises a refrigerant fluid accumulation device 8 disposed downstream of the first exchanger 3 and upstream of the first expansion valve 31. In other words, the receiver-dryer 8 is disposed between the third exchanger 3 and the first expansion valve 31.

The third heat exchanger 3 is thermally coupled to the element 25 of a drive train of the vehicle, via the heat transfer liquid in the heat transfer liquid circuit 20.

The third heat exchanger 3 thus makes it possible to supply a thermal power to the element 25 of the drive train of the vehicle, which is to say to heat this element 25. The second exchanger 2 makes it possible for its part to receive a thermal power from the element 25, in order to cool it or collect energy. The heat transfer liquid circuit 20 has not been set out in detail, and is shown in dashed line at the third exchanger 3 and at the second exchanger 2. To make the representation simpler and avoid the lines of the various circuits crossing one another, the circuit 20 is shown in two separate parts.

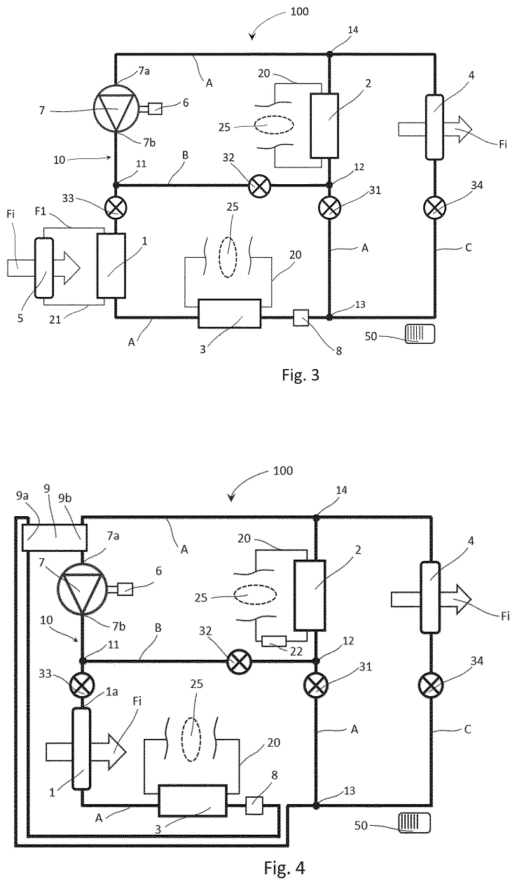

FIG. 3 illustrates a variant of the embodiment in FIG. 2. In this variant, the heat transfer fluid F1 is a heat transfer liquid configured to circulate in a fifth heat exchanger 5 configured to exchange heat with an air stream Fi inside the vehicle interior.

The fifth heat exchanger 5 is disposed on a second heat transfer liquid circuit 21. The vehicle interior is heated indirectly, since the heat of condensation of the refrigerant fluid is firstly transferred to the heat transfer liquid in the circuit 21, and then the heat of the heat transfer liquid is transferred to the internal air stream Fi at the fifth exchanger 5. A pump, not shown, can circulate the heat transfer liquid in the circuit 21. The other exchangers have the same role as they do in the first embodiment in FIG. 2. The heat transfer liquid circuit 21 for the heating of the vehicle interior and the heat transfer liquid circuit 20 for the thermal coupling to the element 25 of the transmission chain are separate, which is to say they are not in communication.

In the second embodiment and also in its variants, the refrigerant fluid circuit 10 comprises a second bypass branch C disposed in parallel with the first expansion valve 31 and the second heat exchanger 2, the second bypass branch C comprising a fourth expansion valve 34 and a fourth heat exchanger 4.

The second bypass branch C fluidically connects a third junction point 13 disposed on the main loop A downstream of the third exchanger 3 and upstream of the first expansion valve 31 to a fourth junction point 14 disposed on the main loop A downstream of the second exchanger 2 and upstream of the compressor 7. The second bypass branch C has a fourth expansion device 34 disposed upstream of the fourth heat exchanger 4.

The fourth heat exchanger 4 is configured to exchange heat with an air stream Fi inside the vehicle interior. The fourth heat exchanger 4 is disposed in the heating, ventilating and/or air conditioning installation.

In the embodiment in FIG. 1 and in the embodiment in FIGS. 2 and 4, where the first exchanger 1 is disposed in the heating, ventilating and/or air conditioning installation, the first exchanger 1 is disposed downstream of the fourth exchanger 4 in a flow direction of the internal air stream Fi. In the variant illustrated in FIG. 3, the fifth exchanger 5 is disposed downstream of the fourth exchanger 4 in the heating, ventilating and/or air conditioning installation. The fourth exchanger 4 makes it possible to ensure the cooling of the vehicle interior in order to keep the occupants of the vehicle thermally comfortable by way of a warm atmosphere.

FIG. 4 shows another variant of the embodiment of the thermal conditioning system 100 in FIG. 2. The main loop A of refrigerant fluid comprises an internal exchanger 9 configured to enable an exchange of heat between the high-pressure refrigerant fluid downstream of the third heat exchanger 3 and upstream of the first expansion valve 31, and the low-pressure refrigerant fluid downstream of the second exchanger 2 and upstream of the compressor 7.

The internal heat exchanger 9 has a first heat exchange section 9a disposed downstream of the refrigerant fluid accumulation device 8 and upstream of the first expansion device 31, and a second heat exchange section 9b disposed downstream of the second heat exchanger 2. Heat is exchanged between the refrigerant fluid in the first heat exchange section 9a and the refrigerant fluid in the second heat exchange section 9b. The internal exchanger 9 makes it possible to improve the performance of the thermal conditioning system 100.

According to a variant which is not shown, the main loop A of refrigerant fluid may have a supercooling exchanger disposed downstream of the accumulation device 8 and upstream of the first expansion valve 31. The supercooling exchanger makes it possible to increase the thermal cooling power, when the thermal conditioning system is used in cooling mode.

1. A method for controlling a thermal conditioning system, the thermal conditioning system comprising:
a heat transfer liquid circuit configured to circulate a heat transfer liquid;
refrigerant fluid circuit having:
a main loop comprising, in succession in a direction of flow of the refrigerant fluid:
a compressor configured to be driven by an electric motor the compressor being configured to bring the refrigerant fluid from an intake pressure to a delivery pressure;
a first heat exchanger configured to supply a thermal power to a heat transfer fluid;
a first expansion valve; and
a second heat exchanger arranged conjointly on the refrigerant fluid circuit and on the heat transfer liquid circuit so as to receive a thermal power from the heat transfer liquid, and
a first bypass branch allowing the refrigerant fluid at an outlet of the compressor to reach the second exchanger by bypassing the first exchanger and the first expansion valve, the first bypass branch having a second expansion valve,
the control method comprising:
receiving a thermal power setpoint for thermal power to be supplied at least to the heat transfer fluid at the first exchanger;
determining an electrical power setpoint for electrical power to be supplied to the electric motor of the compressor on a basis of the received thermal power setpoint for thermal power to be supplied and on the basis of the thermal power received by the second exchanger;
determining a delivery pressure setpoint on the basis of the determined electrical power setpoint and on the basis of a maximum delivery pressure;
determining an intake pressure setpoint on the basis of the determined electrical power setpoint and on the basis of the determined delivery pressure setpoint;
controlling a rotational speed of the electric motor of the compressor such that the electrical power supplied to the compressor is equal to the determined setpoint;
controlling a passage cross section of the second expansion valve such that the intake pressure of the compressor is equal to the determined intake pressure setpoint; and
controlling a passage cross section of the first expansion valve such that the refrigerant fluid at an inlet of the compressor is in a superheated steam state.

2. The control method as claimed in claim 1, wherein the main loop of the refrigerant fluid circuit comprises a third expansion valve arranged downstream of the compressor and upstream of the first heat exchanger, the method further comprising:
controlling a refrigerant fluid passage cross section in the third expansion valve such that the delivery pressure is equal to the delivery pressure setpoint.

3. The control method as claimed in claim 1, further comprising:
determining a superheating of the refrigerant fluid at the inlet of the compressor; and
controlling a passage cross section of the first expansion valve such that the superheating of the refrigerant fluid at the inlet of the compressor is equal to a setpoint value.

4. The control method as claimed in claim 1, further comprising:
determining a superheating of the refrigerant fluid at the outlet of the compressor; and
controlling a passage cross section of the first expansion valve such that the superheating of the refrigerant fluid at the outlet of the compressor is equal to a setpoint value.

5. The control method as claimed in claim 1,
wherein the main loop of the thermal conditioning system comprises, downstream of the first heat exchanger and upstream of the first expansion valve, a third heat exchanger arranged conjointly on the refrigerant fluid circuit and on the heat transfer liquid circuit so as to enable an exchange of heat between the refrigerant fluid and the heat transfer liquid, the third heat exchanger being configured to supply a thermal power to the heat transfer liquid,
wherein the thermal power setpoint for thermal power to be supplied is a total thermal power, which is a sum of the thermal power to be supplied to the heat transfer fluid at the first exchanger and the thermal power to be supplied to the heat transfer liquid at the third exchanger.

6. The control method as claimed in claim 1, wherein the heat transfer fluid is an internal air stream inside a motor vehicle interior.

7. The control method as claimed in claim 1, wherein the heat transfer fluid is a heat transfer liquid configured to circulate in a fifth heat exchanger configured to exchange heat with an air stream inside a vehicle interior.

8. The control method as claimed in claim 1, wherein the second heat exchanger is thermally coupled to an element of a drive train of a vehicle, via the heat transfer liquid in the heat transfer liquid circuit.

9. The control method as claimed in claim 5, wherein the third heat exchanger is thermally coupled to an element of a drive train of a vehicle, via the heat transfer liquid in the heat transfer liquid circuit.

10. A thermal conditioning system comprising:
a heat transfer liquid circuit configured to circulate a heat transfer liquid; refrigerant fluid circuit having:
a main loop comprising, in succession in the direction of flow of the refrigerant fluid:
a compressor configured to be driven by an electric motor, the compressor being configured to bring the refrigerant fluid from an intake pressure to a delivery pressure;
a first heat exchanger configured to supply a thermal power to a heat transfer fluid;
a first expansion valve; and,
a second heat exchanger arranged conjointly on the refrigerant fluid circuit and on the heat transfer liquid circuit so as to receive a thermal power from the heat transfer liquid, and
a first bypass branch allowing the refrigerant fluid at the outlet of the compressor to reach the second exchanger by bypassing the first exchanger and the first expansion valve the first bypass branch comprising a second expansion valve; and
an electronic control unit configured to implement the control method as claimed in claim 1.

11. The thermal conditioning system as claimed in claim 10,
wherein the refrigerant fluid circuit comprises a second bypass branch disposed in parallel with the first expansion valve and the second heat exchanger,
wherein the second bypass branch comprising:
a fourth expansion valve; and
a fourth heat exchanger,
wherein the fourth heat exchanger is configured to exchange heat with an air stream inside a vehicle interior.

12. The thermal conditioning system as claimed in claim 10, wherein the main loop of refrigerant fluid comprises a refrigerant fluid accumulation device disposed downstream of the first exchanger and upstream of the first expansion valve.
